(19) United States
(12) Patent Application Publication
(10) Pub. No.: US 2008/0097677 A1
(43) Pub. Date: Apr. 24, 2008

(54) Driving force control apparatus

(75) Inventor: Seiji Kawakami, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/907,367

(22) Filed: Oct. 11, 2007

(30) Foreign Application Priority Data
Oct. 13, 2006 (JP) P2006-280372

(51) Int. Cl. G06F 17/00

(52) U.S. Cl. 701/99

(57) ABSTRACT

A driving force control apparatus has an electronically-controlled throttle valve for regulating an intake air mass of an engine, and an ECU for controlling this electronically-controlled throttle valve. The ECU keeps an opening of the electronically-controlled throttle valve constant to restrain increase of engine output, in a region where a position of an accelerator pedal (accelerator travel) is not less than a predetermined travel AC1. The ECU relaxes the restraint on the output of the engine when a predetermined output restraint relaxation condition is satisfied, e.g., when a speed of a vehicle becomes higher than a predetermined speed (e.g., 20 km/h), or when the shift position is a predetermined position (e.g., D1 (first gear fixed), or D2 (second gear fixed) position).

### BACKGROUND OF THE INVENTION

1. Field of the Invention

The present invention relates to driving force control apparatus and, more particularly, to a driving force control apparatus for suppressing a sudden change of vehicle behavior caused by a stepping error on an accelerator pedal.

2. Related Background Art

There is the conventionally proposed technology of detecting a stepping error on the accelerator pedal instead of the brake pedal and suppressing a sudden vehicle behavior change against driver's intention such as a sudden start or sudden acceleration occurring as a result of the stepping error (e.g., Patent Document 1: Japanese Patent Application Laid-open No. 05-256170).

Patent Document 1 discloses the following technology: when the driver steps largely on the accelerator pedal in a situation in which an obstacle is detected in front of the vehicle from the detection result of a laser sensor, the throttle valve is forcibly closed, while judging that the driver made a stepping error on the accelerator pedal.

### SUMMARY OF THE INVENTION

It is, however, difficult to zero erroneous detection of the obstacle in real complex circumstances (traffic circumstances and natural environments) where the vehicle is located. Therefore, it is also difficult to perfectly zero erroneous detection in detection of the stepping error on the accelerator pedal from the detection result of the obstacle and the position of the accelerator pedal. If erroneous detection occurs in the absence of any obstacle, the throttle valve will be closed on the basis of the judgment of the stepping error and it could cause the driver to feel strong inconsistency. If the sensor fails to detect an obstacle in the presence of the obstacle conversely, it can result in failure to suppress the sudden change of vehicle behavior caused by the stepping error on the accelerator pedal.

The present invention has been accomplished in order to solve the above problem, and an object of the present invention is to provide a driving force control apparatus capable of reliably suppressing the sudden change of vehicle behavior caused by the stepping error on the accelerator pedal, while preventing the driver from feeling strong inconsistency.

A driving force control apparatus according to the present invention is a driving force control apparatus for suppressing a sudden change of vehicle behavior caused by a stepping error on an accelerator pedal, the driving force control apparatus comprising an output control unit for controlling an output of a power plant for generating a driving force to drive a vehicle, wherein the output control unit restrains the output of the power plant in a region where a position of the accelerator pedal is not less than a predetermined value, and relaxes the restraint on the output of the power plant if a predetermined output restraint relaxation condition is satisfied.

The driving force control apparatus according to the present invention is arranged to restrain the output of the power plant in the region where the position of the accelerator pedal is not less than the predetermined value, without detecting whether the stepping operation on the accelerator pedal is an error. For this reason, the apparatus is able to reliably suppress the sudden change of vehicle behavior even in situations where the stepping operation on the accelerator pedal is an error. On the other hand, the output of the power plant is not restrained in the region where the position of the accelerator pedal is less than the predetermined value and thus normal start acceleration performance can be ensured, which can prevent the driver from feeling strong inconsistency. Since the restraint on the output of the power plant is relaxed if the predetermined output restraint relaxation condition is satisfied, the driver's demand can also be met, for example, under a drive condition in which high output (high torque) is required.

In the driving force control apparatus according to the present invention, preferably, the output control unit relaxes the restraint on the output of the power plant if a speed of the vehicle is higher than a predetermined speed. This configuration can prevent acceleration failure in the middle and high speed region where the speed of the vehicle is higher than the predetermined speed, during normal driving.

Preferably, the output control unit relaxes the restraint on the output of the power plant if a reduction gear ratio of an automatic transmission is smaller than a predetermined gear ratio. This configuration can prevent acceleration failure in the middle and high speed region where the reduction gear ratio of the automatic transmission becomes smaller than the predetermined gear ratio, during normal driving.

Preferably, the output control unit relaxes the restraint on the output of the power plant if a shift position of an automatic transmission is a predetermined position. For example, an operation of selecting a shift position except for D (drive), R (reverse), and N (neutral) is an operation to require high output (high torque). Since the driving force control apparatus according to the present invention relaxes the restraint on the output of the power plant in this case, degradation of drivability can be prevented.

The driving force control apparatus according to the present invention is preferably configured as follows: it further comprises a cancel switch for canceling the restraint on the output of the power plant, and the output control unit cancels the restraint on the output of the power plant if the cancel switch is turned on. This configuration permits the driver to turn on the cancel switch, whereby the apparatus is adaptable for a situation in which high output (high torque) is needed in the low speed region, e.g., at a start on a steep upgrade.

Preferably, the output control unit brings the cancel switch into an off state if a predetermined drive condition is met. This configuration can reliably prevent the driver from forgetting to return the cancel switch (or from forgetting to turn off the switch).

The driving force control apparatus according to the present invention is preferably configured as follows: it further comprises a grade detecting unit for detecting a grade of a driving road, and the output control unit raises an output restraint value of the power plant according to a magnitude of an up grade of the driving road. This configuration makes it feasible to output a required drive torque, for example, at a start on an upgrade or the like.

The driving force control apparatus according to the present invention is preferably configured as follows: it further comprises a grade detecting unit for detecting a grade of a driving road, and the output control unit lowers an output restraint value of the power plant according to a magnitude of a down grade of the driving road. This configuration makes it feasible to reliably suppress the sudden change of vehicle behavior, also taking the grade of the driving road into consideration, e.g., at a start on a downgrade or the like.

According to the present invention as described above, the driving force control apparatus is constructed in the configuration wherein the output of the power plant is restrained in the region where the position of the accelerator pedal is not less than the predetermined value and wherein the restraint on the output of the power plant is relaxed if the predetermined output restraint relaxation condition is satisfied, whereby it becomes feasible to reliably suppress the sudden change of vehicle behavior caused by the stepping error on the accelerator pedal, while preventing the driver from feeling strong inconsistency.

### BRIEF DESCRIPTION OF THE DRAWINGS

FIG. 1 is a block diagram showing a configuration of the driving force control apparatus according to the first embodiment.

FIG. 2 is a drawing showing relations between accelerator travel and throttle opening (throttle opening characteristics).

FIG. 3 is a flowchart showing a processing procedure of driving force control executed by the driving force control apparatus according to the first embodiment.

FIG. 4 is a block diagram showing a configuration of the driving force control apparatus according to the second embodiment.

FIG. 5 is a drawing for explaining road grade correction for an output restraint characteristic.

### DESCRIPTION OF THE PREFERRED EMBODIMENTS

The preferred embodiments of the present invention will be described below in detail with reference to the drawings. In the drawings identical or equivalent portions will be denoted by the same reference symbols.

### First Embodiment

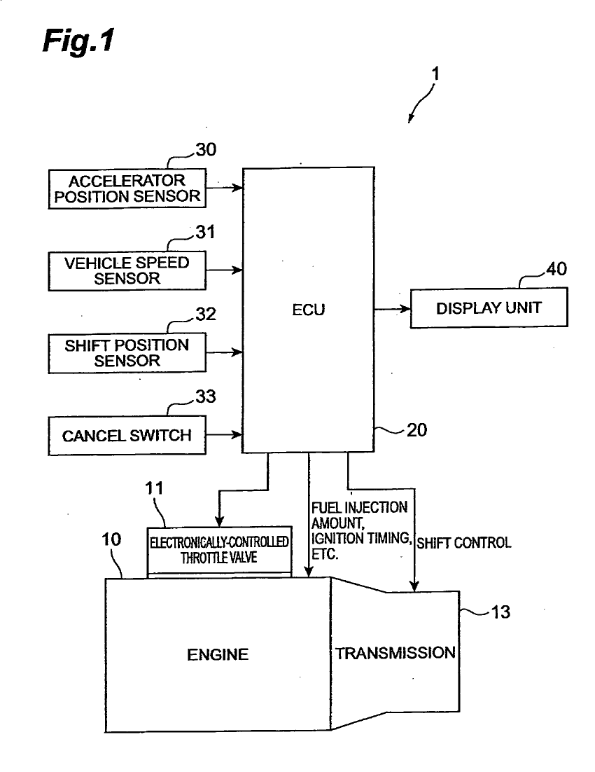

First, a configuration of driving force control apparatus 1 according to the first embodiment will be described using FIG. 1. FIG. 1 is a block diagram showing the configuration of the driving force control apparatus 1.

The driving force control apparatus 1 is arranged to restrain an output of engine 10 being a power plant for generating a driving force to drive a vehicle, from increasing over a predetermined value, in a region where a position of an accelerator pedal is not less than a predetermined value, and to relax the restraint on the output of the engine 10 if a predetermined output restraint relaxation condition is satisfied, whereby the apparatus suppresses a sudden change of vehicle behavior against driver's intention, e.g., sudden starting, sudden acceleration, and so on, caused by a stepping error on the accelerator pedal, while preventing the driver from feeling strong inconsistency.

In the present embodiment, the engine 10 used is a gasoline engine whose output torque can be controlled according to intake air mass. This engine 10 is of a port injection type to inject fuel into an intake port, but may be of a direct injection type to inject fuel directly into each cylinder of the engine. An induction pipe of the engine 10 is equipped with an electronically controlled throttle valve 11 for controlling the intake air mass. This electronically-controlled throttle valve 11 is connected to an after-described electronic control unit (hereinafter referred to as “ECU”) 20 and is actuated by a control signal from the ECU 20.

A transmission 13 for converting the output torque from the engine 10 and outputting converted torque is connected to an output shaft of the engine 10. The transmission 13 is a multi-speed automatic transmission arranged to implement an automatic shift change by a hydraulic mechanism.

The torque outputted from the engine 10 is transmitted through the transmission 13, differential gear (not shown), and drive shaft (not shown) to drive wheels of the vehicle.

The engine 10 and transmission 13 are systematically controlled by ECU 20. The following components are connected to the ECU 20: the aforementioned electronically-controlled throttle valve 11; an accelerator position sensor 30 for detecting a position of the accelerator pedal, i.e., an accelerator travel; a vehicle weed sensor 31 for detecting a speed of the vehicle; a shift position sensor 32 for detecting the position of the shift lever, and a cancel switch 33 for canceling the restraint on the output of the engine 10, and the detection results of the respective sensors and an operation state of the switch are fed to the ECU 20.

The ECU 20 is composed of a microprocessor for performing calculation, a ROM for storing programs and others for letting the microprocessor execute each processing, a RAM for storing various data such as the calculation result, a backup RAM whose stored contents are held by a 12V battery, and so on.

The ECU 20 actuates the electronically-controlled throttle valve 11 to adjust the intake air mass of engine 10, based on the aforementioned information from the various sensors and others, and adjusts the fuel injection amount (air-fuel ratio), injection timing, etc. to control the output of engine 10, based on information such as the intake air mass detected by an air flow meter.

The ECU 20 controls mainly the opening of the electronically-controlled throttle valve 11 at a constant level to restrain the output of engine 10 from increasing over a predetermined value, in a region where the position of the accelerator pedal (accelerator travel) is not less than a predetermined value, and relaxes the restraint on the output of the engine 10 when at least one condition is satisfied out of the following conditions: a predetermined output restraint relaxation condition is satisfied, e.g., the speed of the vehicle becomes higher than a predetermined speed (e.g., 20 km/h); a reduction gear ratio of the transmission 13 becomes smaller than a predetermined gear ratio (e.g., a gear ratio of the second gear); the shift position is a predetermined position (e.g., D1 (first gear fixed) or D2 (second gear fixed) position); and the cancel switch 33 is in an on state. Namely, the ECU 20 and electronically-controlled throttle valve 11 function as the output control unit as set forth in the scope of claims.

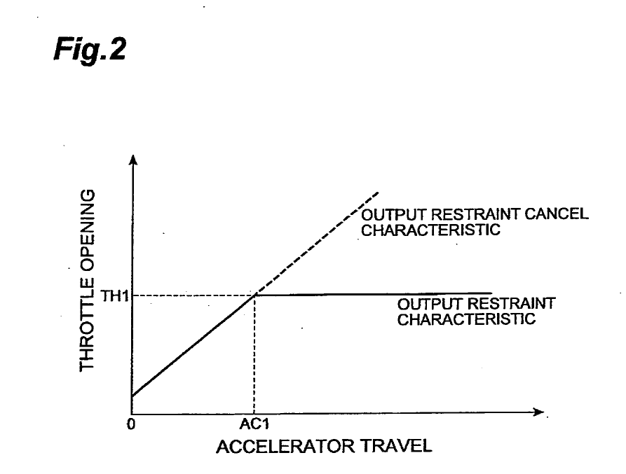

FIG. 2 shows an example of relationship between the position of the accelerator pedal (accelerator travel) and the valve opening (throttle opening) of the electronically-controlled throttle valve 11, i.e., throttle opening characteristics. In FIG. 2, the horizontal axis resents the accelerator travel (deg) and the vertical axis the throttle opening (deg). As indicated by a dashed line in FIG. 2, the characteristic with the restraint on the output of engine 10 being canceled is so set that the throttle opening linearly monotonically increases with increase in accelerator travel (hereinafter referred to as “output restraint cancel characteristic”).

On the other hand, as indicated by a solid line, the characteristic with the restraint on the output of engine 10 being effected is set as follows. Specifically, in a region where the accelerator travel is from 0 to a predetermined travel AC1, the characteristic is so set that the throttle opening linearly monotonically increases to a predetermined opening TH1 with increase in accelerator travel, as in the case where the output restraint is canceled. In a region where the accelerator travel is from the predetermined travel AC1 to the maximum, the characteristic is so set that the throttle opening is kept constant at the predetermined opening TH1 (hereinafter referred to as “output restraint characteristic”). For this reason, increase in intake air mass and increase in fuel injection amount according to intake air mass both are restrained in this region whereupon increase in the output of engine 10 is restrained. The restraint value TH1 of the throttle opening is set based on a driving force that is needed in normal driving on relatively flat roads.

The ECU 20 also performs control on the shift of transmission 13, based on various information including the accelerator travel, vehicle speed, shift position, and so on.

A display unit 40 is also connected to the ECU 20. The display unit 40 displays various information such as the output restraint information to draw driver's attention. The display unit 40 suitably applicable is a liquid crystal display, a head-up display, or the like.

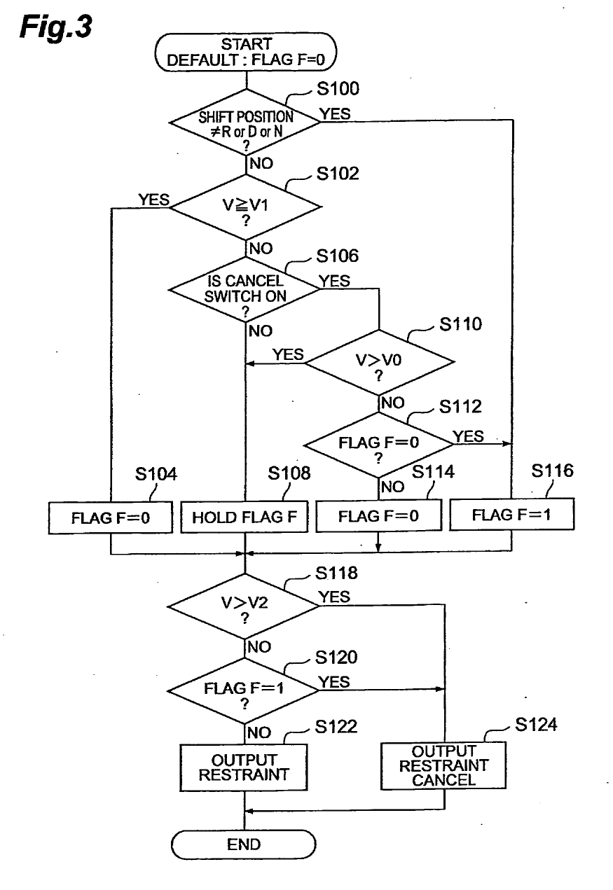

Next, the operation of the driving force control apparatus 1 will be described with reference to FIG. 3. FIG. 3 is a flowchart showing a processing procedure of driving force control executed by the driving force control apparatus 1. This control is repeatedly executed at predetermined timing by the ECU 20 during a period from on to off of power. When the ECU 20 is activated, the initial value of “0” is set in flag F for switching the output state of engine 10. The output of engine 10 is restrained with the flag F being “0,” and the restraint on the output of the engine 10 is canceled with the flag F being “1.”

In step S100, it is determined whether the shift position read from the shift position sensor 32 is a position except for D (drive), R (reverse), and N (neutral). When the shift position is one of these three positions, the processing shifts to step S102. On the other hand, when the shift position is one except for these three positions, e.g., when the shift position is D1 (first gear fixed) or D2 (second gear fixed) or the like, it is judged that the driver demands high output (high torque), the processing shifts to step S116 to set “1” in the flag F, and thereafter the processing shifts to step S118.

When the step S100 ends in the negative, i.e., when the shift position is D (drive), R (reverse), or N (neutral), it is determined in step S102 whether the vehicle speed V is not less than a predetermined speed V1 (e.g., 40 km/h). When the vehicle speed V is not less than the predetermined speed V1, “0” is set in the flag F in step S104, in order to prevent the driver from forgetting to return the cancel switch 33 (or from forgetting to turn off the switch), and thereafter the processing shifts to step S118. On the other hand, when the vehicle speed V is less than the predetermined speed V1, the processing shifts to step 5106.

In step S106, it is determined whether the cancel switch 33 is in an on state. When the cancel switch 33 is in the on state, the processing shifts to step S110. On the other hand, when the cancel switch 33 is in an off state, the current state of the flag F is kept unchanged in step S108 and the processing shifts to step S118.

In step S110, it is determined whether the vehicle speed V is higher than a predetermined speed V0 (which is set to a speed (e.g., 39 km/h) equal to or slightly lower than the predetermined speed V1). When the vehicle speed V is higher than the predetermined speed V0, the switch operation with the cancel switch 33 is regarded as invalid, the current state of the flag F is kept unchanged in step S108, and the processing shifts to step S118. On the other hand, when the vehicle speed V is not more than the predetermined speed V0, the switch operation with the cancel switch 33 is regarded as valid and the processing shifts to step S112.

In step S112, it is determined whether the flag F is “0.” When the flag F is “0,” “1” is set in the flag F in step S116 and thereafter the processing shifts to step S118. On the other hand, when the flag F is “1,” “0” is set in the flag F in step S114 and thereafter the processing shifts to step S118.

After the flag F is thus set in step S104, S108, S114, or S116, it is determined in step S118 whether the vehicle speed V is higher than a predetermined speed V2 (e.g., 20 km/h). When the vehicle speed V is higher Man the predetermined speed V2, the processing shifts to step S124. On the other hand, when the vehicle speed V is not more than the predetermined speed V2, the processing shifts to step S120. Instead of or in addition to this vehicle speed condition, it is also possible to adopt a configuration wherein the processing shifts to step S124 when the reduction gear ratio of the transmission 13 is smaller the a predetermined gear ratio (e.g., the second gear ratio); and the processing shifts to step S120 when the reduction gear ratio is not less than the predetermined gear ratio.

In step S120, it is determined whether the flag F is “1.” When the flag F is “0,” the processing shifts to step S122. On the other hand, when the flag F is “1,” the processing shifts to step S124.

In step S122, the electronically-controlled throttle valve 11 is driven according to the output restraint characteristic indicated by the solid line in FIG. 2. Namely, the throttle opening is increased to the predetermined opening TH1 with increase in accelerator travel in the region where the accelerator travel is from 0 to the predetermined travel AC1, but the throttle opening is kept constant at the predetermined opening T′H1 in the region where the accelerator travel is from the predetermined travel AC1 to the maximum. For this reason, the increase in intake air mass and the increase in fuel injection amount according to intake air mass both are restrained in this region whereupon the increase in the output of engine 10 (i.e., increase in driving force) is restrained. Thereafter, the ECU leaves this processing once.

On the other hand, in step S124, the electronically-controlled throttle valve 11 is driven according to the output restraint cancel characteristic indicated by the dashed line in FIG. 2. Namely, the increase in throttle opening is not restrained in this case and the throttle opening can increase up to WOT (wide open) according to increase in accelerator travel. For this reason, the output of engine 10 (or driving force) is not restrained, either, and the driving force is outputted corresponding to the throttle opening. Thereafter, the ECU leaves this processing once.

In the present embodiment, without detecting whether the stepping operation on the accelerator pedal is an error, the throttle opening is kept constant at the predetermined opening TH1 in the region where the position of the accelerator pedal (accelerator travel) is not less than the predetermined travel AC1, whereby the increase in the output of engine 10 is restrained. For this reason, the sudden change of vehicle behavior can be reliably suppressed even if the stepping operation on the accelerator pedal is an error.

Since the present embodiment provides gentler acceleration than full-throttle acceleration even with a stepping error on the accelerator pedal, the driver can be prevented from going into a panic. As a result, the driver can retain mental composure and enough time to perform a step switching operation onto the brake pedal or the like, and it thus becomes easier to perform an avoidance operation in the event of stepping error. Furthermore, even if a contact with an obstacle cannot be avoided, the speed and driving force of the vehicle will be reduced upon the contact, and thus the damage due to the contact can be reduced to the vehicle.

On the other hand, since the present embodiment is arranged not to restrain the output of engine 10 in the region where the accelerator travel is less an the predetermined travel AC1, so as to ensure the normal staring acceleration performance, the driver can be prevented from feeling strong inconsistency.

Since the present embodiment is arranged to relax the restraint on the output of the engine 10 in the region where the speed V of the vehicle is higher than the predetermined speed V2 (e.g., 20km/h), acceleration failure in the middle and high speed region can be prevented during normal driving. When the shift position selected is one except for D (drive), R (reverse), and N (neutral), it is judged that the driver demands high output (high torque), and the restraint on the output of the engine 10 is relaxed, whereby degradation of drivability can be prevented. Since the driver does not have to turn on the cancel switch 33 by manipulating the shift position, complexity of cancel operation can be reduced.

In the present embodiment, when the predetermined drive condition is met, i.e., when the vehicle speed V becomes not less than the predetermined speed V1 (e.g., 40 km/h), the cancel switch 33 is turned off and “0” is set in the flag F. For this reason, it becomes feasible to reliably prevent the driver from forgetting to return the cancel switch (or from forgetting to turn off the switch).

### Second Embodiment

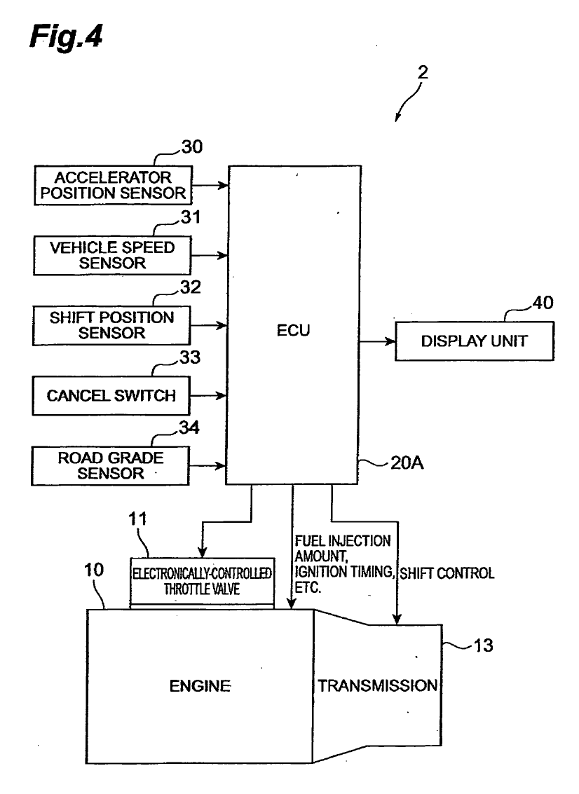

Next, a configuration of driving force control apparatus 2 according to the second embodiment will be described using FIG. 4.

FIG. 4 is a block diagram showing the configuration of the driving force control apparatus 2. In FIG. 2 identical or equivalent components to those in the first embodiment are denoted by the same reference symbols.

The driving force control apparatus 2 is different from the aforementioned first embodiment in that it is provided with a road grade sensor 34 for detecting a grade (up grade or down grade) of a driving road at a stop or during low-speed steady driving and provided with an ECU 20A for restraining the output of engine 10 also taking the road grade into consideration, instead of the ECU 20. The road grade sensor suitably applicable is an acceleration sensor or the like. The other configurations are the same as or similar to those in the aforementioned first embodiment, and thus the description thereof is omitted herein.

The road grade sensor 34 is connected to the ECU 21 and road grade information detected thereby is fed to the ECU 20A.

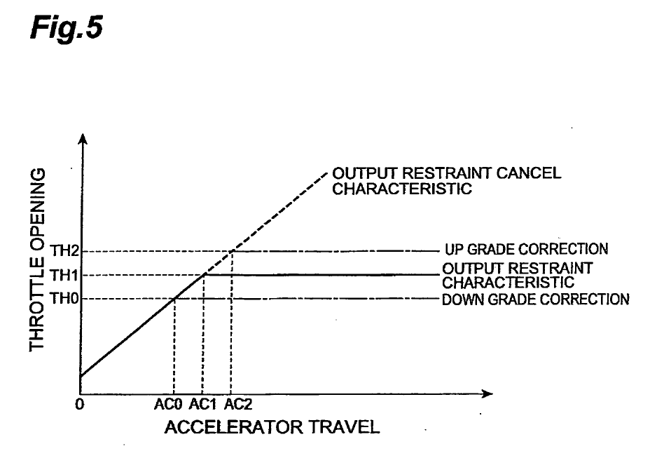

The ECU 20A corrects the aforementioned output restraint characteristic, based on the input road grade. The road grade correction for the output restraint characteristic will be described below with reference to FIG. 5. FIG. 5 is a drawing for explaining the road grade correction for the output restraint characteristic. The output restraint characteristic indicated by a solid line in FIG. 5 is a characteristic in the case where the road grade is zero, i.e., on flat roads. The output restraint characteristic indicated by the solid line and the output restraint cancel characteristic indicated by the dashed line in FIG. 5 are the same as the aforementioned output restrain characteristic and output restraint cancel characteristic shown in FIG. 2, and thus the description thereof is omitted herein.

The ECU 20A first calculates a force component Fg acting on the vehicle in a direction parallel to a road surface, by Eq (1) below, using the input road grade θ and vehicle weight Ma
Fg=M·g·sin(θ) (1)

In the equation, g is the acceleration of gravity.

Subsequently, the road grade correction for the output restraint characteristic is performed based on the calculated force component Fg. Namely, in a case where the driving road has an up grade, as indicated by a chain line in FIG. 5, the output restraint characteristic is corrected so as to increase by a degree equal to a throttle opening (TH2−TH1) corresponding to an output torque increased according to the force component Fg. As a result, the output restraint characteristic after the road grade correction is so set that the throttle opening is linearly monotonically increased up to a predetermined opening TH2 with increase in accelerator travel, in a region where the accelerator travel is from 0 to a predetermined travel AC2 and that the throttle opening is kept constant at the predetermined opening TH2 in a region where the accelerator travel is from the predetermined travel AC2 to the On the other hand, in a case where the driving road has a down grade, the output restraint characteristic is corrected so as to decrease by a degree equal to a throttle opening (TH1−TH0) corresponding to an output torque decreased according to the force component Fg. As a result, the out restraint characteristic after the road grade correction is so set that the throttle opening is linearly monotonically increased up to a predetermined opening TH0 with increase in accelerator travel, in a region where the accelerator travel is from 0 to a predetermined travel AC0 and that the throttle opening is kept constant at the predetermined opening TO in a region where the accelerator travel is from the predetermined travel AC0 to the maximum.

Next, the operation of the driving force control apparatus 2 will be described with reference to FIG. 3 described above. The operation of the driving force control apparatus 2 is different only in the processing content of step S122 in the flowchart shown in FIG. 3, from the first embodiment. The other processing contents are identical or similar to the aforementioned contents, and therefore the description thereof is omitted herein.

In the present embodiment, step S122 is to calculate the force component Fg acting on the vehicle in the direction parallel to the road surface, and to perform the road grade correction for the output restraint characteristic, based on the calculated force component Fg. Then the electronically-controlled throttle valve 11 is driven according to the corrected output restraint characteristic, i.e., the output restraint characteristic indicated by either of the chain lines in FIG. 5. Namely, when the driving road has an up grade, the throttle opening is increased up to the predetermined opening TH2 with increase in accelerator travel in the region where the accelerator travel is from 0 to the predetermined travel AC2, but the throttle opening is kept constant at the predetermined opening TH2 in the region where the accelerator travel is from the predetermined travel AC2 to the maximum. When the driving road has a down grade, the throttle opening is increased up to the predetermined opening TH0 with increase in accelerator travel in the region where the accelerator travel is from 0 to the predetermined travel AC0, but the throttle opening is kept constant at the predetermined opening TH0 in the region where the accelerator travel is from the predetermined travel AC0 to the maximum.

Since the present embodiment is arranged to effect the correction to raise the output restraint characteristic of the engine 10 on the basis of the up grade of the driving road, it becomes feasible to output a required drive torque, e.g., at a start on an upgrade. Since the cancel switch 33 does not have to be turned on at every start on an upgrade, complexity of cancel operation can be reduced.

Since the present embodiment is arranged to effect the correction to lower the output restraint characteristic of engine 10 on the basis of the down grade of the driving road, the sudden change of vehicle behavior can be reliably suppressed also taking the grade of the driving road into consideration, e.g., at a start on a downgrade.

The above described the embodiments of the present invention, but it is noted that the present invention is not limited to the above embodiments but can be modified in many ways. In the above embodiments, the gasoline engine was used as a power plant for generating the driving force, but the gasoline engine may be replaced, for example, by a diesel engine whose output torque can be controlled according to fuel injection amounts, or by an electric motor. An electric motor may also be used in addition to the gasoline engine (or the diesel engine).

Since the above embodiments used the gasoline engine as a power plant for generating the driving force, the throttle opening was kept constant as a technique of restraining the output; however, where the diesel engine is used instead of the gasoline engine, the fuel injection amount is kept constant to limit the increase of output. In the case of an electric automobile using an electric motor instead of the gasoline engine, a power supply amount is kept constant to limit the increase of output. Furthermore, in the case of a hybrid vehicle using an electric motor in addition to the gasoline engine, the throttle opening and power supply amount are kept constant to limit the increase of output.

The above embodiments used the multi-speed automatic transmission as a transmission, but it is also possible, for example, to use a belt type or toroidal type continuously variable transmission or the like.

The second embodiment was arranged to detect the road grade by means of the acceleration sensor, but it is also possible, for example, to adopt a configuration wherein when a backward motion of the vehicle is detected at the D (drive) position or when a forward motion of the vehicle is detected at the R (reverse) position, the road is determined to have an up grade and the output restraint characteristic is corrected by a degree equal to a predetermined opening.

What is claimed is:

1. A driving force control apparatus for suppressing a sudden change of vehicle behavior caused by a stepping error on an accelerator pedal,
the driving force control apparatus comprising an output control unit for controlling an output of a power plant for generating a driving force to drive a vehicle,
wherein the output control unit restrains the output of the power plant in a region where a position of the accelerator pedal is not less than a predetermined value, and relaxes the restraint on the output of the power plant if a predetermined output restraint relaxation condition is satisfied.

2. The driving force control apparatus according to claim 1, wherein the output control unit relaxes the restraint on the output of the power plant if a speed of the vehicle is higher than a predetermined speed.

3. The driving force control apparatus according to claim 1, wherein the output control unit relaxes the restraint on the output of the power plant if a reduction gear ratio of an automatic transmission is smaller than a predetermined gear ratio.

4. The driving force control apparatus according to claim 1, wherein the output control unit relaxes the restraint on the output of the power plant if a shift position of an automatic transmission is a predetermined position.

5. The driving force control apparatus according to claim 1, further comprising a cancel switch for canceling the restraint on the output of the power plant,
wherein the output control unit cancels the restraint on the output of the power plant if the cancel switch is turned on.

6. The driving force control apparatus according to claim 5, wherein the output control unit brings the cancel switch into an off state if a predetermined drive condition is met.

7. The driving force control apparatus according to claim 1, further comprising a grade detecting unit for detecting a grade of a driving road,
wherein the output control unit raises an output restraint value of the power plant according to a magnitude of an up grade of the driving road.

8. The driving force control apparatus according to claim 1, further comprising a grade detecting unit for detecting a grade of a driving road,
wherein the output control unit lowers an output restraint value of the power plant according to a magnitude of a down grade of the driving road.
